(19) United States
(12) Patent Application Publication
(10) Pub. No.: US 2012/0032458 A1
(43) Pub. Date: Feb. 9, 2012

(54) BUMPER SYSTEM WITH FRICTION-FIT ENERGY ABSORBER AND METHOD

(75) Inventors: Ryan Johnson Brooks, Allen Park, MI (US); Wayne C. Graves, Royal Oak, MI (US); Michael Anthony Rossi, Grosse Ile, MI (US); Daric Morell, Novi, MI (US); Joel Matthew Cormier, Lathrup Village, MI (US)

(73) Assignee: OAKWOOD ENERGY MANAGEMENT, INC., Dearborn, MI (US)

(21) Appl. No.: 13/155,612

(22) Filed: Jun. 8, 2011

Related U.S. Application Data
(60) Provisional application No. 61/370,526, filed on Aug. 4, 2010.

(51) Int. Cl. B60R 19/03; B23P 11/02; B29C 51/42

(52) U.S. Cl. 293/120; 264/319; 29/446

(57) ABSTRACT

A bumper system includes a bumper beam having top and bottom attachment features, such as apertures or concavities for attachment. A thermoformed polymeric energy absorber includes a base flange for engaging the face of the beam, protruding crush lobes for absorbing energy upon an impact, and top and bottom rear flanges. The top and bottom rear flanges include inwardly-facing protrusions defining a second dimension less than a first dimension of the beam's face, but the base flange is sufficiently resilient and flexible at desired locations and with desired force of flexures to provide tunable flexure points so the protrusions can be temporarily resiliently flexed apart to the first dimension for assembly and then upon release, the protrusions flex back to the second dimension engaging the attachment features to temporarily but positively retain the energy absorber on the beam.

### CROSS REFERENCE TO RELATED APPLICATION

This non-provisional application incorporates by reference and claims the benefit of U.S. provisional patent application Ser. No. 61/370,526 filed Aug. 4, 2010 under 35 U.S.C. §119(e).

### TECHNICAL FIELD

The present invention relates to bumper systems for passenger vehicles, and more particularly to a bumper system having a beam and thermoformed energy absorber that resiliently friction-fits onto the beam with sufficient force for self-retention. However, it is contemplated that the present invention is not limited to only thermoforming processes nor thermoformed parts, nor to bumper beams, nor to passenger vehicles.

### BACKGROUND

Passenger vehicles require bumper systems to protect vehicle components, reduce injury to pedestrians, and translate load for the triggering of air bag deployment during an impact. Often, a polymeric energy absorber is fastened to a bumper system by press-fit or secondary fasteners (e.g., screws, push pins, or brackets) and/or is attached via secondary processes (e.g., welding, bending, or bonding), or is held in place by other means (e.g., by attaching the energy absorber to a RIM fascia cover aesthetically covering a front end of a vehicle). However, secondary fasteners and processes add expense due to the use of additional parts, additional manpower, and additional assembly time.

Injection molded energy absorbers sometimes have attachment flanges with integral connectors. However, integral connectors add cost to the tooling, particularly where they require slides or cams for action in the mold tooling . . . , which is usually the case for positively-engaging integral connectors, since these connectors require blind surfaces for creating the positive retention. Persons skilled in the art of injection molding understand that it is difficult to release molded parts with blind surfaces from mold tooling unless there are slides or cams in the tooling to eliminate interference conditions that prevent release of the parts. However, slide and/or cams add considerable expense to injection molding tooling and to maintenance costs. Persons skilled in the automotive industry know that it is extremely competitive, and that every additional fastener or additional secondary attachment process costs money, time, and effort. Also, complex and expensive tools add to overhead costs

### SUMMARY

In one aspect of the present invention; a bumper system for a passenger vehicle including a bumper beam having face, top and bottom surfaces, with the top and bottom surfaces including attachment features that are one of apertures or concavities for attachment; the top and bottom surfaces defining a first vertical dimension. The bumper system further includes an energy absorber with a base flange for engaging the face surface, protruding crush lobes for absorbing energy upon an impact, and top and bottom rear flanges. The top and bottom rear flanges include inwardly-facing protrusions defining a second dimension less than the first dimension but the base flange is sufficiently resilient at tunable flexure points where the protrusions can be temporarily flexed apart to the first dimension for assembly and then upon release the protrusions flex back to the second dimension engaging the one attachment feature to temporarily retain the energy absorber on the beam.

In another aspect of the present invention, a method of assembly comprises steps of providing a bumper beam having face, top and bottom surfaces, with the top and bottom surfaces including attachment features that are one of apertures or concavities for attachment; the top and bottom surfaces defining a first vertical dimension; providing an energy absorber with a base flange for engaging the face surface, protruding crush lobes for absorbing energy upon an impact, and top and bottom rear flanges; the top and bottom rear flanges including inwardly-facing protrusions defining a second dimension less than the first dimension; and assembling the energy absorber onto the beam by resiliently flexing the base flange where the protrusions are temporarily flexed apart to the first dimension for assembly and then upon release the protrusions flex back to the second dimension to temporarily engage the one attachment feature to retain the energy absorber on the beam.

In yet another aspect of the present invention, a method of thermoforming an energy absorber for a vehicle bumper system includes steps of providing tooling having a molding surface shaped to form an energy absorber with a base flange and protruding crush lobes for absorbing energy upon an impact, and top and bottom rear flanges; heating a polymeric sheet of material and forming same on the tooling including forming a base flange having a first dimension and forming top and bottom rear flanges with inwardly-facing protrusions defining a second dimension less than the first dimension; and removing the energy absorber from the tooling by resiliently flexing the base flange where the protrusions are temporarily flexed apart to the first dimension and then upon release, allowing the protrusions to flex back to the second dimension.

In one aspect of the present invention, a bumper system for a passenger vehicle comprises a bumper beam having front, top, bottom and rear surfaces; the top and bottom surfaces defining a first vertical dimension; and an energy absorber with a base flange for engaging the front surface, protruding crush lobes for absorbing energy upon an impact, and top and bottom rear flanges. The top and bottom rear flanges include inwardly-facing protrusions defining a second dimension less than the first dimension but the base flange is sufficiently resilient and flexible so the protrusions can be temporarily flexed apart to the first dimension for assembly and then upon release the protrusions flex back to the second dimension engaging a rear surface of the beam to retain the energy absorber on the beam.

In another aspect of the present invention, a system includes a beam having front, rear, top and bottom surfaces; the top and bottom surfaces defining a first vertical dimension; and a thermoformed energy absorber with a base flange for engaging the front surface, protruding crush lobes for absorbing energy upon an impact, and top and bottom rear flanges. The top and bottom rear flanges include inwardly-facing protrusions defining a second dimension less than the first dimension but the base flange is sufficiently resilient and flexible the protrusions can be temporarily flexed apart to the first dimension for assembly onto the beam and then upon release the protrusions flex back to the second dimension engaging the beam to temporarily retain the energy absorber on the beam as a front spacer on the beam.

These and other aspects, objects, and features of the present invention will be understood and appreciated by those skilled in the art upon studying the following specification, claims, and appended drawings.

### BRIEF DESCRIPTION OF THE DRAWINGS

FIG. 1 is a vertical cross-sectional view of a bumper system including a bumper beam and self-attached energy absorber.

FIG. 2 is a perspective view of the energy absorber of FIG. 1.

FIG. 3 is an enlarged view of the flexing engagement of the energy absorber with the beam from FIG. 1.

FIGS. 4-5 are vertical cross-sectional and perspective views of a modified beam and energy absorber, the views FIGS. 4-5 being similar to FIGS. 1-2.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

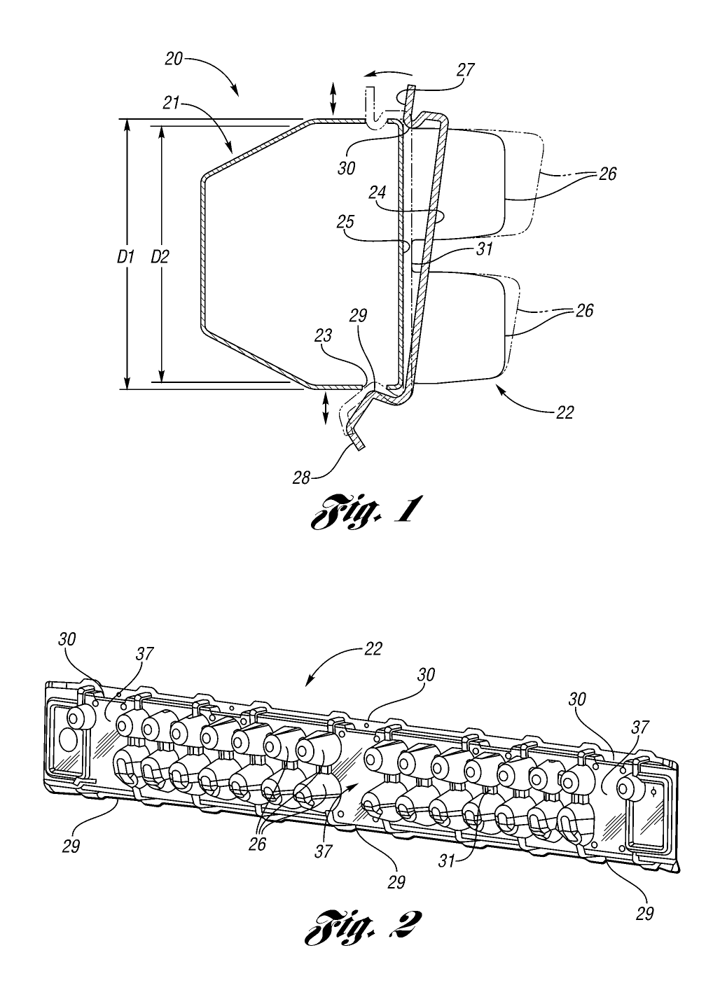

A vehicle bumper system 20 (FIGS. 1-3) includes a bumper beam 21 and a thermoformed energy absorber 22 that “snaps” onto a face of the beam 21 for self-retention. The illustrated beam 21 is a single-tube beam that includes integrally-formed top and bottom attachment features, such as apertures 23 (or flanges or channels or concavities, not specifically shown) for frictionally positive engagement with a mating feature (i.e., protrusions 29/30) on the energy absorber 22.

The thermoformed polymeric energy absorber 22 includes a base flange 24 for engaging the face 25 (e.g., front wall) of the beam 21, protruding crush lobes 26 (two rows shown, most being cone shaped, but more or less a different arrangement of crush lobes or modified crush lobes could be used, such as a modified smaller crush lobe at each end) for absorbing energy upon an impact, and top and bottom rear flanges 27 and 28. The top and bottom rear flanges 27 and 28 include inwardly-facing undercuts or protrusions 29 and 30 defining a second dimension D2 less than a first dimension D1 of the beam's face 25. The base flange 24 (particularly in the location 31 between the crush lobes 26) is sufficiently resilient and flexible to provide tunable flexure points where the protrusions 29 and 30 can be temporarily resiliently flexed apart (noting that the gradient of the flexure can be tuned from 29 to 30, such that one is more rigid than the other) to the first dimension Dl for assembly and then upon release, the protrusions 29 and 30 flex back to the second dimension D2 engaging the attachment features (apertures 23) to temporarily but positively retain the energy absorber 22 on the beam 21 until the fascia is attached over the bumper system 20. Notably, a resiliency of the location 31 can be tuned for optimal gripping/clamping action (and insertion/retention),—such as by adding channel ribs (shown) or changing a material thickness or embossment at that location. It is contemplated that the protrusions 29-30 could be made to engage a rear surface of the beam 21 instead of the features 23.

It is noted that a cross car locator can be formed in the energy absorber 22, such as by forming a lobe extending into a hole in the bumper beam's front wall. It is also contemplated that the energy absorber 22 could be formed with ends that resiliently flex and engage ends of the beam 21.

It has been found that the attachment scheme for the energy absorber 22 can be improved to meet customer expectations so that the energy absorber remains on the beam after sequential FMVSS tests. The improvement is made by adding the spaces 37 in energy absorber 22 (FIG. 2) at center and end locations near attachments/snaps. The spaces 37 are created by basically eliminating columns of cones nearest to snaps, which prevents the energy absorber 22 from splaying open during impact and releasing from the associated beam. Specifically, testing has shown that a footprint of an energy absorber 22 may increase as its lobes 26 become compressed and individual lob base diameters increase (i.e. open up). The increase in footprint could cause an energy absorber to disengage from the beam 21 prior to the final impact in a series of impacts/collisions. Straps/spaces 37 are areas of the energy absorber that are void of lobes. Straps/spaces 37 can be added between protrusions 29/30 to prevent the distance between such protrusions from increasing during impact.

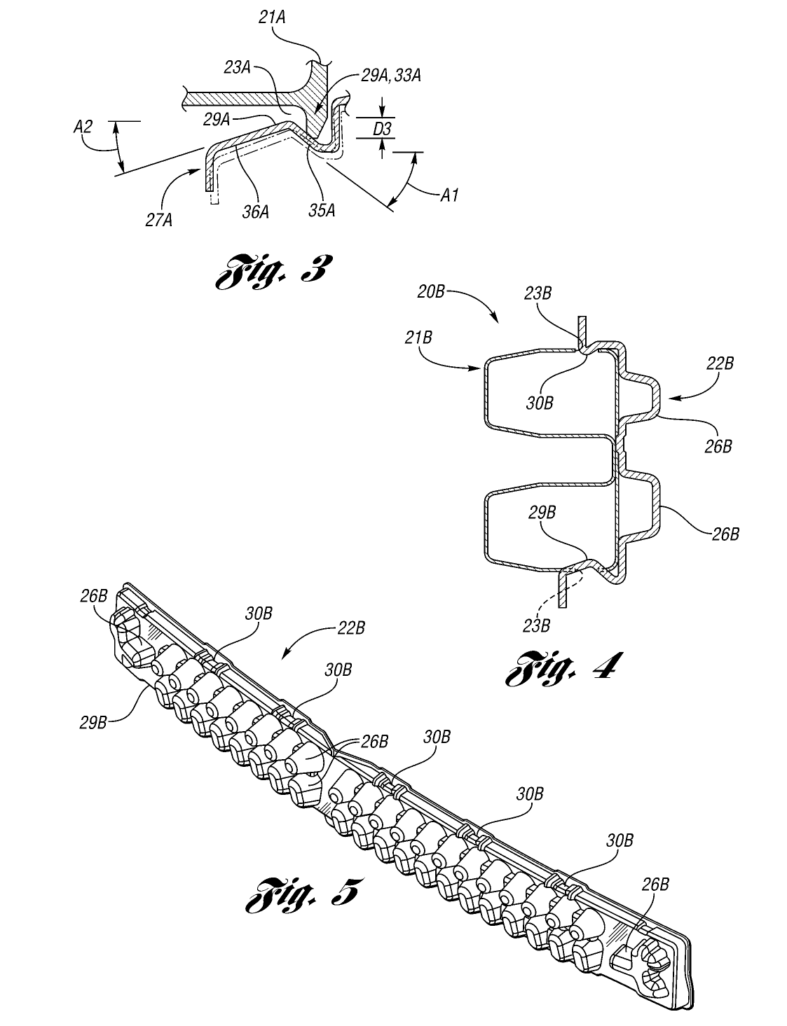

Modified bumper systems are shown in FIGS. 3 and 4-5. In these systems, similar and identical components and features are identified using the same numbers, but with the addition of a letter “A” or “B”.

In FIG. 3, the protrusion 29A engages a concavity 23A in a modified beam 21A. The illustrated beam 21A includes a longitudinally extending down (or up) flange 33A forming with a remainder of the beam 21A the concavity 23A. Notably, the channel can be either spaced apart short depressions along a length of the beam, or a continuous long channel along the beam 21A. The illustrated beam 21A is an aluminum extrusion with a down flange 33A forming the recess 23A. However, it is contemplated that the beam 21A could be roll formed to include a channel recess or a doubled-back wall section forming the recess 23A adjacent a back side of the flange 33A. The beam can also be stamped, hot-stamped LFT, composite, or other. The illustrated flanges 27A (and protrusions 29A) extend in an undercut direction D3 by at least about 4-5 mm (and more preferably about 4 mm) and has a first wall 35A at an angle A1 of about 15 to 60 degrees or more preferably about 30 to 45 degrees for providing positive retention after engagement, and has a second trailing wall 36A at an angle A2 of about 5 to 45 degrees or more preferably about 10 to 30 degrees for providing an easier insertion force for assembly of the energy absorber 22A onto the beam 21A (i.e., insertion/retention forces can be tuned to meet customer requirements). Also, the length of the trailing wall 36A can be made longer than the first wall 35A, if desired in order to provide a longer ramp to facilitate assembly.

The bumper system 20B (FIGS. 4-5) includes a double-tube beam 21B and energy absorber 22B. The features are generally similar and the discussion of same will not be repeated. It is noted that the crush lobes 26B at each end are modified to be T-shaped. The protrusions 29B and 30B are slightly deeper and the wall thickness increased in energy absorber 22B, such that it is noted that the thermoform tooling may require action (i.e., a cam or slide) in order to easily release the energy absorber 22B from the thermoform tooling die.

There are several advantages to the present inventive concepts. This is the first time that flanges on a beam have been used to attach a thermoformed energy absorber to a bumper beam. The attachment system is relatively simple and the parts are relatively easy make (i.e., roll form or extrude or other manufacturing methods of the beam 21, 21A, 22A, or thermoform the energy absorber 22, 22A, 22B). Notably the attachment system can be tuned to provide an optimal force of assembly and optimal retention force to prevent disassembly. For example, a bending resiliency of the base flange (especially the area 31 between the top and bottom crush lobes 26) can be affected by the material properties, increasing or decreasing wall thickness, addition of channel ribs or ridges for selective stiffening, and other means. Notably, the undercuts or protrusions 29 and 30 are small enough to be released from the thermoform tool without requiring action in the mold tooling. (It is noted that the thermoform tooling could include slides or cams in order to produce the undercuts, however, it is not contemplated that this would be required since the thermoformed energy absorbers can be flexed to release the protrusions 29 and 30 from the tooling without substantial difficulty. Nonetheless, a slide/cam may be used in the thermoform tooling if the undercuts are more than 5 mm deep.)

The resiliency of the energy absorber 22 causes the energy absorber 22 to engage the beam 21 in a manner that reduces or eliminates buzzes, squeaks and/or rattles, which can be a problem in vehicles at certain vibrations. The retention strength is easily adjusted, such as by changing an insertion or retention angle of the mating surfaces of the protrusions 29/30 and the attachment features (i.e., apertures 23 or mating channels), or by providing slits or breeches or gusset ribs in the energy absorber 22. Further, the aperture 23 in the beam 21 can include a relatively sharp corner that engages the protrusions 29/30, making the beam 21 bite into the energy absorber for increased retention force.

The present system has several advantages, including elimination of secondary fasteners, reduced steps in the manufacture of parts and in the assembly of parts, reduced risk of buzzes/squeaks/rattles, reduced need for secondary equipment at the assembly plant and concurrent savings in floor space, reduced overall mass due to use of a thermoformed sheet product rather than an injection molded energy absorber, and reduces overall system cost versus other systems (such as systems using separate fasteners and/or EPP foam).

It is noted that the energy absorber 22 is thermoformed from a sheet of polymer having a uniform thickness. The sheet is heated and then drawn down onto a thermoform mold into the shape of the final energy absorber. It is contemplated that different thermoform processes can be used to manufacture the energy absorber 22, such as vacuum thermoforming, and that the thermoforming process can use a single lower die or pair of top and bottom opposing dies.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A bumper system for a passenger vehicle comprising:
a bumper beam having face, top and bottom surfaces, with the top and bottom surfaces including attachment features that are one of apertures or concavities for attachment; the top and bottom surfaces defining a first vertical dimension; and
an energy absorber with a base flange for engaging the face surface, protruding crush lobes for absorbing energy upon an impact, and top and bottom rear flanges; the top and bottom rear flanges including inwardly-facing protrusions defining a second dimension less than the first dimension but the base flange being sufficiently resilient and flexible to provide tunable flexure points where the protrusions can be temporarily flexed apart to the first dimension for assembly and then upon release the protrusions flex back to the second dimension engaging the one attachment feature to temporarily retain the energy absorber on the beam.

2. The bumper system defined in claim 1, wherein the one includes the apertures.

3. The bumper system defined in claim 1, wherein the one includes the concavities.

4. The bumper system defined in claim 1, wherein the one includes at least one longitudinally-extending concave channel.

5. The bumper system defined in claim 1, wherein the protrusions include at least one longitudinally-extending ridge.

6. The bumper system defined in claim 1, wherein the protrusions form opposing jaws that self-clamp onto the beam.

7. The bumper system defined in claim 1, wherein the protrusions form a plurality of opposing jaw pairs spaced longitudinally apart.

8. The bumper system defined in claim 1, wherein energy absorber comprises a thermoformed polymeric sheet that is heated and formed into a three-dimensional component.

9. A method of assembly comprising steps of:
providing a bumper beam having face, top and bottom surfaces, with the top and bottom surfaces including attachment features that are one of apertures or concavities for attachment; the top and bottom surfaces defining a first vertical dimension;
providing an energy absorber with a base flange for engaging the face surface, protruding crush lobes for absorbing energy upon an impact, and top and bottom rear flanges; the top and bottom rear flanges including inwardly-facing protrusions defining a second dimension less than the first dimension; and
assembling the energy absorber onto the beam by resiliently flexing the base flange where the protrusions are temporarily flexed apart to the first dimension for assembly and then upon release the protrusions flex back to the second dimension to temporarily engage the one attachment feature to retain the energy absorber on the beam.

10. A method of thermoforming an energy absorber component comprising steps of:
providing tooling having a molding surface shaped to form an energy absorber with a base flange and protruding crush lobes for absorbing energy upon an impact, and top and bottom rear flanges;
heating a polymeric sheet of material and forming same on the tooling including forming a base flange having a first dimension and forming top and bottom rear flanges with inwardly-facing protrusions defining a second dimension less than the first dimension; and
removing the energy absorber from the tooling by resiliently flexing the base flange where the protrusions are temporarily flexed apart to the first dimension and then upon release, allowing the protrusions to flex back to the second dimension.

11. The method defined in claim 10, including a step of attaching the energy absorber to a bumper beam by resiliently flexing the protrusions apart for assembly and then releasing the energy absorber so that the protrusions flex back and into engagement with the beam.

12. The method defined in claim 10, including a step of attaching the energy absorber to a beam by resiliently flexing the protrusions apart for assembly and then releasing the energy absorber so that the protrusions flex back and into engagement with the beam, thus acting as a spacer on the beam.

13. A bumper system for a passenger vehicle comprising:
a bumper beam having front, top, bottom and rear surfaces; the top and bottom surfaces defining a first vertical dimension; and
an energy absorber with a base flange for engaging the front surface, protruding crush lobes for absorbing energy upon an impact, and top and bottom rear flanges; the top and bottom rear flanges including inwardly-facing protrusions defining a second dimension less than the first dimension but the base flange being sufficiently resilient and flexible so the protrusions can be temporarily flexed apart to the first dimension for assembly and then upon release the protrusions flex back to the second dimension engaging a rear surface of the beam to retain the energy absorber on the beam.

14. A system comprising:
a beam having front, rear, top and bottom surfaces; the top and bottom surfaces defining a first vertical dimension; and
a thermoformed energy absorber with a base flange for engaging the front surface, protruding crush lobes for absorbing energy upon an impact, and top and bottom rear flanges; the top and bottom rear flanges including inwardly-facing protrusions defining a second dimension less than the first dimension but the base flange being sufficiently resilient and flexible the protrusions can be temporarily flexed apart to the first dimension for assembly onto the beam and then upon release the protrusions flex back to the second dimension engaging the beam to temporarily retain the energy absorber on the beam as a front spacer on the beam.
